(19) United States
(12) Patent Application Publication
(10) Pub. No.: US 2026/0192140 A1
(43) Pub. Date: Jul. 9, 2026

(54) ENCLOSURE WITH FIRE SUPPRESSION SYSTEM

(71) Applicant: William A. Enk, Key Largo, FL (US)

(72) Inventor: William A. Enk, Key Largo, FL (US)

(21) Appl. No.: 19/431,908

(22) Filed: Dec. 23, 2025

Related U.S. Application Data
(60) Provisional application No. 63/741,629, filed on Jan. 3, 2025.

(51) Int. Cl. A62C 3/00; A62C 35/13; B65D 88/12; B65D 90/22

(52) U.S. Cl. CPC A62C 3/002; A62C 35/13; B65D 88/121; B65D 90/22

(57) ABSTRACT

A cargo containment system with fire suppression is provided for holding cargo during storage or transport. The cargo containment system includes an outer cargo structure with one or more surfaces, an inner enclosure configured to be positioned within the outer cargo structure, and a fire suppression device located within the outer cargo structure. The inner enclosure includes one or more openings for fluid communication into the inner enclosure. The cargo containment system includes one or more gaps located between the outer cargo structure and the inner enclosure. The fire suppression device can discharge a fire extinguishing agent into the outer cargo structure to flow along the gaps and into the inner enclosure to suppress a potential fire hazard occurring within the inner enclosure.

### CROSS-REFERENCE TO RELATED APPLICATIONS

This Application claims priority to U.S. Provisional Patent Application Ser. No. 63/741,629, filed on Jan. 3, 2025, to William A. Enk, entitled “Enclosure with Fire Suppression System,” currently pending, the entire disclosure of which is incorporated herein by reference.

### BACKGROUND OF THE INVENTION

Cargo containers are used for storage, shipping and transport of various cargo and goods on aircraft and other transport modes, as well as in various storage systems. The cargo containers are generally modular systems that provide a fully-enclosed compartment for housing the cargo during storage and/or transport as well as loading and unloading. Various rules and regulations often require such cargo container systems to have certain fire hazard safety protections due to the potential hazardous, combustible, and/or flammable nature of the cargo or goods being transported, such as clothing, batteries and other goods. Additionally, it is also often desirable to have fire protection means provided within other types of enclosed spaces, such as closets, rooms, storage compartments and the like, that house flammable or combustible material. However, one problem with the fire protection means of existing containers and enclosures is that the cargo or material within the container or enclosure is loaded and situated such that the fire suppression system is unable to protect and extinguish the fire hazard within the container or enclosure. Notably, the cargo or material within the container or enclosure gets positioned against one or more walls of the interior of the enclosure, which prevents any fire suppression agent from adequately surrounding the cargo or material to fully suppress and/or extinguish the fire within the enclosure. Accordingly, a need exists for an enclosure system with improved fire suppression means for adequately suppressing a potential fire hazard that may occur within the enclosure.

### SUMMARY

The present invention is directed to a cargo containment system with fire protection, detection and suppression means. The cargo containment system can include an outer cargo structure, an inner enclosure, and a fire suppression device. The outer cargo structure includes at least one wall or surface that forms an outer boundary with an interior space or volume contained therein. The outer cargo structure can be configured as a cargo container with one or more walls. The outer cargo structure can be configured as a tarp or cover. The outer cargo structure can be configured as a room, or storage compartment.

The inner enclosure is configured to be positioned within the interior space of the outer cargo structure. The inner enclosure can include at least one wall or surface that defines an outer boundary of the inner enclosure and defines an inner cargo chamber therein. The at least one wall or surface can form a porous, permeable or semi-permeable barrier layer of the inner enclosure. The at least one wall or surface can include one or more openings or perforations that provide fluid communication between the inner cargo chamber and the exterior of the inner enclosure.

The dimensions of the inner enclosure may be less than the dimensions of the outer cargo structure. One or more gaps may be formed between the interior surface of the outer cargo structure and the exterior surface of the inner enclosure when the inner enclosure is located within the outer cargo structure. The gap can be configured with any suitable width for forming a dispersion path sufficient to enable fluid communication between the inner enclosure and the interior surface of the outer cargo structure.

The fire suppression device can be located at least partially within the interior space of the outer cargo structure. The fire suppression device can be positioned above the inner enclosure when the inner enclosure is located within the outer cargo structure. The fire suppression device can include one or more fire, smoke, heat, and/or gas sensors for detecting the presence of a potential fire hazard within the outer cargo structure. The fire suppression device can include an extinguishant unit for discharging a fire extinguishing or suppressing agent into the interior space of the outer cargo structure.

The fire suppression device can be located within the dispersion path formed within the outer cargo structure. Upon the detection of an actual or potential fire hazard occurring within the outer cargo structure, the fire suppression device can discharge the fire extinguishing agent from the extinguishant unit. The extinguishing agent is enabled to flow along the dispersion path and along the gaps between the inner enclosure and the interior surface of the outer cargo structure. The extinguishing agent may further travel through the one or more openings in the surface of the inner enclosure and into the inner cargo chamber in order to protect cargo contained within the inner enclosure and suppress the potential fire hazard occurring therein.

Further advantages, features and details of the invention are elucidated on the basis of preferred embodiments thereof, wherein reference is made to the accompanying drawings.

### BRIEF DESCRIPTION OF THE DRAWINGS

In the accompany drawings, which form a part of the specification and are to be read in conjunction therewith in which like reference numerals are used to indicate like or similar parts in the various views:

FIG. 1 is a schematic perspective view of a cargo container system in accordance with one embodiment of the present invention;

FIG. 2 is a schematic top plan view of a cargo container system in accordance with one embodiment of the present invention;

FIG. 3 is a schematic front elevation view of the cargo container system of FIG. 2;

FIG. 4 is a schematic side elevation view of the cargo container system of FIG. 2; and

FIG. 5 is a schematic perspective view of a fire suppression system of the cargo container system of FIG. 2 in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed generally to a cargo containment system or cargo container system 10 that includes improved fire protection, detection, and suppression means as illustrated in the several figures and described herein. While the invention is described herein as a cargo containment system 10 for holding cargo intended for storage and/or transport, the invention may suitably be configured for any type of fixed or movable enclosure. For example, the present invention may be directed to an enclosure system 10, wherein the enclosure is a room, closet, storage compartment, or other enclosure that is designed to house and store material that may be flammable or combustible. Accordingly, the term cargo containment system 10 may refer to any enclosure system 10, cargo structure 12 may refer to any outer enclosure or structure 12 (including cargo containers, cargo tarps or covers, containers, closets, rooms, storage compartments and the like), and the term cargo 15 may refer to any material intended for storage or placement within an enclosed area (including cargo, goods, products, materials and combustible materials).

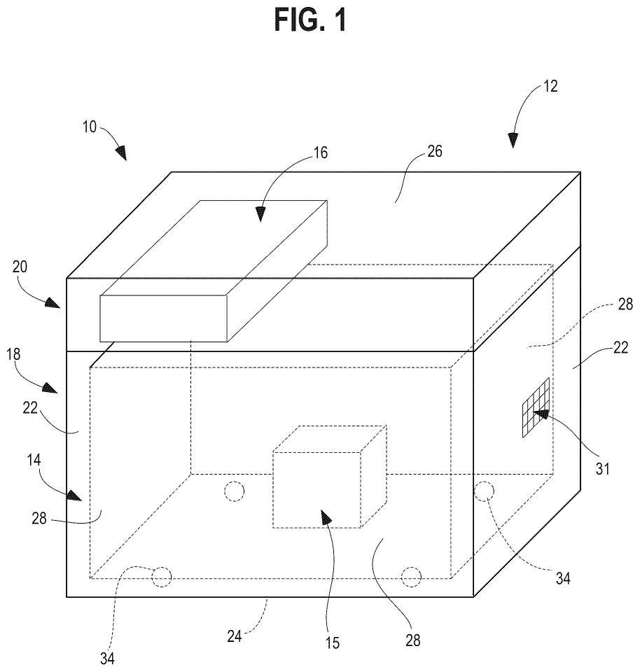

As shown in FIG. 1, cargo containment system 10 may be configured for use in the shipping and transport of cargo 15, such as but not limited to clothing, batteries, and other various goods and materials. Specifically, cargo containment system 10 may be configured for housing cargo 15 that is potentially combustible, flammable and/or fire hazardous. Cargo containment system 10 may be configured for use on aircraft, shipping trailers, long-haul transport systems and other shipping and transport mechanisms. Additionally, as described above, cargo containment system 10 may be configured as any fixed or movable enclosure or containment system 10 for holding combustible materials configured as cargo 15, goods, products or other material.

As best illustrated in FIG. 1, cargo containment system 10 may include an outer cargo structure, cargo container or outer shell 12, an interior enclosure 14 and a fire suppression system 16. According to certain embodiments, outer cargo structure 12 may include a main body section 18 that houses interior enclosure 14 and a top section 20 that houses fire suppression system 16. As shown in the several figures, cargo structure 12 may include one or more exterior side walls or surfaces 22, a bottom base wall or surface 24, and a top wall or surface 26 that defines an interior space or volume within cargo structure 12 and fully encloses the interior space thereof. Cargo structure 12 may further include a door (not shown) formed into one of the side walls 22 that allow for access to the interior space of cargo structure 12. In addition, in certain configurations, top section 20 may be removable from main body section 18 and/or partially rotatable relative to main body section 18 to provide access to the interior space of cargo structure 12.

According to certain embodiments, as illustrated in FIG. 1, cargo structure 12 may be configured as a rigid enclosed structure or shell and have sidewalls 22, a bottom wall 24 and a top wall 26 that provides a fully enclosure structure with an interior space therein. According to certain embodiments, cargo structure 12 may be configured as a flexible structure or shell, such as a tarp, cover or similar component that can be positioned and arranged to define an enclosed structure with an interior space for receiving the interior enclosure 14 having cargo 15. In such embodiments, the flexible structure of the cargo structure 12 forms an enclosure surface 22 that collectively forms the sidewalls or surfaces 22 and top wall or surface 26 of cargo structure 12. An optional bottom wall 24 may be provided underneath the flexible structure to provide a base for the interior enclosure 14.

As further shown in FIG. 1, interior enclosure 14 is configured to be housed within the interior space of cargo structure 12 and may be configured as a fixed or removable structure. Enclosure 14 may be configured as a rigid structure or as a flexible liner or membrane. As shown in the figures, the dimensions of interior enclosure 14 may be less than the corresponding dimensions of cargo structure 12 so that cargo structure 12 may accommodate interior enclosure 14. Interior enclosure 14 may include at least one wall or surface 28 that defines the exterior boundary of enclosure 14 and defines an inner cargo chamber 29 therein. As shown in FIG. 1, interior enclosure 14 may include four side walls and a bottom wall that collectively form the walls 28 of interior enclosure 14; however, more or less walls 28 may be provided in various embodiments. Collectively, the walls 28 of interior enclosure 14 may form a barrier for cargo 15 loaded into interior enclosure 14 when placed within cargo structure 12. According to certain embodiments, interior enclosure 14 may be configured as a flexible liner and may be formed by a wrap that is placed around cargo 15 and holds the cargo 16 in a secure, fixed position. In certain embodiments, the wall or walls 28 may be configured as a surface or multiple surfaces that define a boundary of the interior enclosure 14.

According to one embodiment, interior enclosure 14 may form a porous, permeable or semi-permeable barrier for the inner cargo chamber therein. The walls 28 of interior enclosure 14 may include one or more openings 31 (see FIG. 1) formed through the surface of the walls 28 to provide fluid communication through the walls 28. In certain embodiments, the walls 28 may be constructed from a porous or permeable material to provide the one or more openings 31. In certain embodiments, the walls 28 may be constructed of metal, plastic, polymer-based materials, and/or composite materials and include a gridded or latticed arrangement to form the one or more openings 31 within interior enclosure 14. FIG. 1 illustrates one exemplary configuration of openings 31 formed within wall 28 of interior enclosure 14; however, openings 31 can be configured in any suitable manner to provide fluid communication through one or more walls 28 of interior enclosure 14. Any suitable material may also be used for the construction of interior enclosure 14 in various embodiments. In certain embodiments, the walls 28 may be constructed from a solid material with one or more holes formed therethrough to provide the one or more openings 31. As described in greater detail below, the one or more openings 31 allow access through the walls 28 of the interior enclosure 14 so that a fire suppression agent dispersed from the fire suppression deice 16 may sufficiently surround cargo that is loaded within interior enclosure 14 and cargo structure 12.

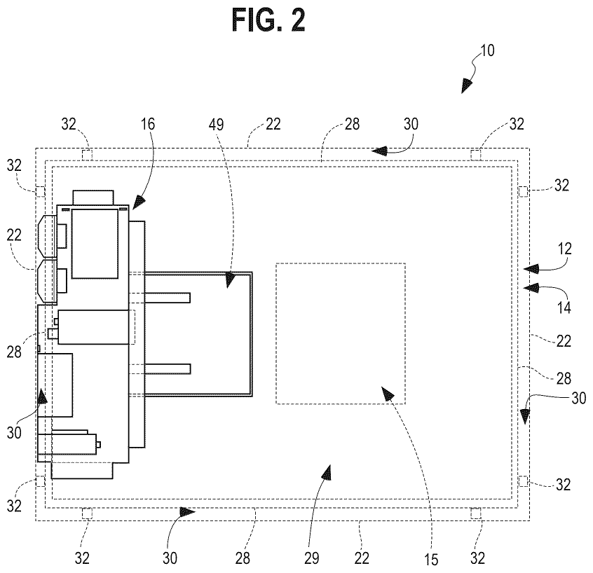

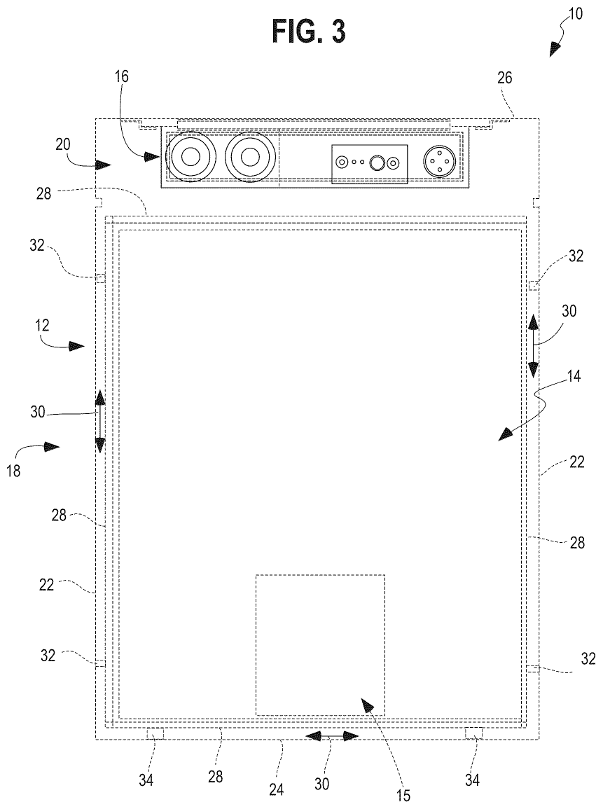

As best illustrated in FIGS. 2-4, the dimensions of interior enclosure 14 may be less than the dimensions of cargo structure 12. The length of each wall 28 of interior enclosure may be slightly less than length of a corresponding wall 22 of the cargo structure 12 so that a gap 30 is provided therebetween when interior enclosure 14 is inserted within cargo structure 12. As shown, the gap 30 may extend the entire height of cargo structure 12. The gap 30 may be configured with any width suitable for enabling sufficient fluid communication and travel of the fire suppression agent discharged within system 10 as described herein. In one specific embodiment, the gap 30 may be at least 0.5 inches. In another embodiment, the width of the gap 30 may be at least 1.0 inches. In other embodiments, the width of the gap 30 may be within a range of 0.25 inches and 12 inches. These specific numerical values and ranges of the width of the gap 30 are merely exemplary and are not intended to be limiting as it is recognized that the width or dimension of the gap 30 may be greater than or less than the numerical values provided in various embodiments of the invention. When the interior enclosure 14 is placed into the cargo structure 12, the gap 30 may extend around the entire perimeter of the interior enclosure 14 so that gap 30 is continuous around the entire boundary space between the walls 22 of cargo structure 12 and the walls 28 of interior enclosure 14. The gap 30 between the walls 22 of the cargo structure 12 and the enclosure 14 may operate to allow a fire suppression agent discharged from the fire suppression device 16 to flow freely within cargo structure 12 and sufficiently surround the enclosure 14 and cargo contained therein to sufficiently suppress a fire within cargo structure 12.

The gap 30 creates a dispersion path between the fire suppression device 16 and the gap 30 located along the surfaces of the interior enclosure 14, which can enable fluid communication between the fire suppression device 16 and the interior enclosure 14 and inner cargo chamber 29 contained therein. When the fire suppression agent is discharged from the fire suppression device 16, the continuous dispersion path allows the suppression agent to flow from the fire suppression device 16 to the interior enclosure 14 and around the interior enclosure 14 without being blocked or impeded. Further, the dispersion path can also allow for gases, smoke and other substances emanating or forming from the cargo 15 within interior enclosure 14 to reach the fire suppression device 16 and one or more sensors 40 located on the fire suppression device 16 for alerting a potential fire hazard associated with the cargo 15.

As further illustrated in FIGS. 2-4, in certain embodiments, interior enclosure 14 may further include one or more spacers 32 provided on the walls 28 of interior enclosure 14. As shown, the spacers 32 may extend outwardly from the walls 28 and into the gap 30 when the interior enclosure 14 is located within cargo structure 12. The spacers 32 may have a width approximately equal to the width of the gap 30 and may operate to maintain the width of gap 30 while enclosure 14 is positioned within cargo structure 12. Specifically, the spacers 32 may operate to prevent the interior enclosure 14 from shifting or moving within cargo structure 12 so that the gap 30 is provided continuously around the entire boundary of interior enclosure 14. As also shown in the figures, interior enclosure 14 may include one or more wheels or similar means 34 that allow interior enclosure 14 to be easily moved into and out of cargo structure 12.

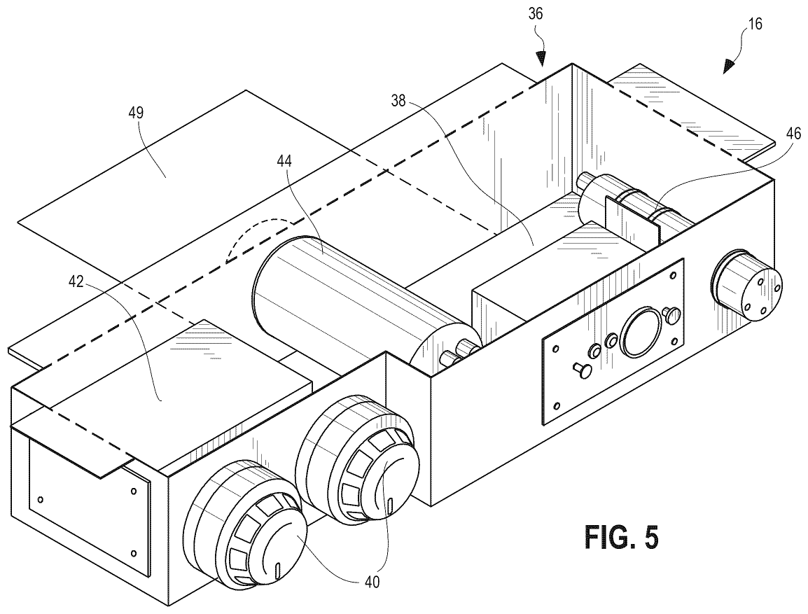

As shown in FIGS. 1-5, cargo containment system 10 may further include a fire suppression device or unit 16 provided within the interior of cargo structure 12. As shown, in certain embodiments, fire suppression device 16 may be located within the top section 20 of cargo structure 12 and above interior enclosure 14. Fire suppression device 16 may be mounted to one or both of outer wall 22 and top wall 26 of cargo structure 12. Cargo containment system 10 may be configured so that a minimum gap or space is provided between the top wall 28 of interior enclosure 14 and the bottom surface of fire suppression device 16 so that discharged extinguishing agent 48 from the fire suppression device 16 may travel in the gap or space above the interior enclosure 14. A barrier component 49 may be attached to and/or extending from the fire suppression device 16 to ensure that gap or space is maintained between the interior enclosure 14 and the fire suppression device 16 (including the discharge end of extinguishant unit 44) so that the upper end of interior enclosure 14 and/or cargo 15 contained therein does not block or impede the fire extinguishing agent 48 from traveling along the dispersion paths throughout the cargo structure 12.

Fire suppression device 16 may be configured as any fire suppression system used for dispersing an extinguishant 48 for fire hazard protection. In certain embodiments, fire suppression device 16 may be configured in the manner described in U.S. Pat. No. 8,973,670, entitled “Fire Suppression System,” U.S. Pat. No. 9,956,445, entitled “Fire Suppression System,” and/or U.S. Pat. No. 11,241,599, entitled “Fire Suppression System.” The entire disclosures of each of the above-listed references are herein incorporated by reference. Any other suitable fire suppression systems and devices may also be used for the fire suppression device 16 of the present invention.

According to one embodiment as shown in the several figures, fire suppression device 16 may include an outer housing or case 36 that contains the components of fire suppression device 16. Fire suppression device 16 may further include a control unit 38, one or more heat, smoke, and/or gas sensors 40, a power source 42 (such as a battery or other suitable source), and an extinguishant unit 44. Extinguishant unit 44 may be configured as a tank that includes a volume of a fire extinguishing/suppressing agent 48 and can be sized to provide enough volume of the agent to effectively extinguish/suppress a fire hazard occurring within cargo structure 12. According to certain embodiments, fire suppression device 16 may include multiple extinguishant units 44 to provide the desired amount of fire extinguishing agent 48. The fire extinguishing agent 48 can be any suitable type of chemical agent now known or hereinafter developed that is adequate or suitable for extinguishing or suppressing a fire, including without limitation, aerosol-based chemical agents, foam-based agents, two-part foam suppressant, or other agents. The fire extinguishing agent may also be configured as any fire extinguishing agent or suppressant material as described in U.S. Pat. No. 8,973,670, entitled “Fire Suppression System,” U.S. Pat. No. 9,956,445, entitled “Fire Suppression System,” and/or U.S. Pat. No. 11,241,599, entitled “Fire Suppression System,” each of which are incorporated herein by reference. As best shown in FIGS. 2, 4 and 5, extinguishant unit 44 may include a discharge outlet or nozzle for dispersing the extinguishing agent 48 outside of the fire suppression system 16 and into cargo structure 12.

Additionally, in certain embodiments, fire suppression device 16 may include a smoke dispersion unit 46. Smoke dispersion unit 46 may be configured to release a smoke generating agent outside of the cargo structure 12 in order to alert of a potential fire hazard occurring within the cargo structure 12 and/or set off detectors or alarms within the surrounding area in which the cargo structure 12 is located (such as an aircraft of other transport means). As shown in FIGS. 2-5, fire suppression device 16 may include a conduit that extents outside of the cargo structure 12 in order to disperse the smoke generating agent from unit 46 upon detection of a potential fire hazard within cargo structure 12.

According to certain embodiments, the heat, smoke, and/or gas sensors 40 may be configured to detect the presence of a gas or aerosol-based substance present within cargo structure 12. In such embodiments, when a gaseous substance emanates from the cargo 15 contained within interior enclosure 14 that may indicate a potential fire hazard, the one or more sensors 40 may send a signal to the control unit 38 of the fire suppression device 16, which may cause the release of a fire extinguishing/suppressing agent 48 within the cargo structure 12 as described herein, and/or the release of a smoke generating agent from a smoke dispensing unit 45 to the outside of cargo structure 12 (as described in greater detail below).

The control unit 38 may control the operation of the fire suppression device 16 and may be configured as any suitable electronic control system. The control unit 38 may be set to control the duration of protection within cargo containment system 10. The control unit 38 may be configured to release the fire suppression agent 48 from fire suppression device 16 all at once, or sequentially. In various embodiments, the control unit 38 may be configured to first release the agent 48 to knock down a fire within cargo structure 12 and then the duration of release may be extended by a sequential release of more agent units into the cargo structure 12. A metering device may be incorporated to regulate the flow of the agent 48 if desired.

The present invention is further directed to a method of protecting cargo and suppressing potential fire hazards within a cargo containment system 10. The method of operating the cargo containment system 10 may operate to cover and surround the cargo with a fire suppression agent 48 in order to control a fire inside or on the surface of the cargo 15. The method may ensure that when the cargo 15 (which may comprise combustible material) is loaded into the container 12, the cargo 15 will not block the distribution of the fire suppression agent 48 from covering and surrounding the entire cargo load inside of the container 12.

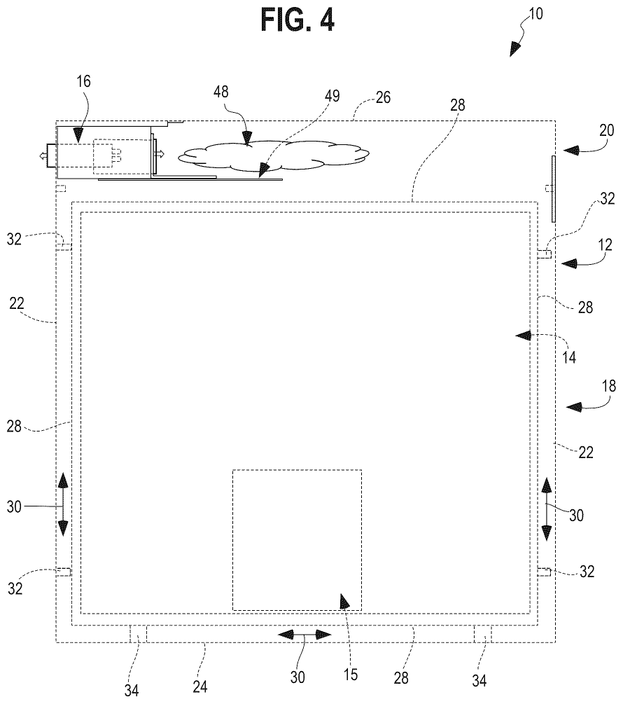

Upon the detection of an actual or potential fire hazard occurring within cargo structure 12, fire suppression device 16 may be configured to discharge fire extinguishing agent 48 from the extinguishant unit 44 (see FIG. 4). Control unit 38 may be configured to signal the release of unit 44 upon detection by heat/smoke detector 40. Control unit 38 may also be configured to signal the release of smoke generating agent from smoke dispersion unit 46. Once the extinguishing agent is discharged from fire suppression device 16, it may travel along and within the gaps 30 provided between the walls 22 of cargo structure 12 and the walls 28 of interior enclosure 14. In particular, the width of the gaps 30 may be maintained by the one or more spacers 32 that ensure a continuous uninterrupted flow path of the gaps 30 to enable the extinguishing agent 48 to easily travel through the gaps 30 and fully surround interior enclosure 14. Additionally, the one or more openings 31 formed through the walls 28 of the interior enclosure 14 enable the extinguishing agent 48 to travel to the interior of the enclosure 14 in order to fully surround the cargo 15 located therein. As a result, the fire suppression system 16 may sufficiently suppress a fire hazard that occurs within cargo structure 12.

Cargo containment system 10 may be configured to provide an initial release of fire suppression agent 48 from fire suppression device 16 to provide initial knock down of a fire hazard within the cargo structure 12. The system 10 may further provide sequential release of fire suppression agent 48 from fire suppression device 16 to sustain the duration of protection for a desired amount of time. Control unit 38 may be configured to provide the multi-stage release of fire suppression agent 48 from fire suppression device 16.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations, locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

As used herein, the term “about” when referring to a measurable value such as an amount, a temporal duration, and the like, can include variations of +/−20%, more preferably +/−10%, even more preferably +/−5% from the specified value, as such variations are appropriate to reproduce the disclosed methods and systems.

From the foregoing, it will be seen that this invention is one well adapted to attain all the ends and objects hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cargo containment system comprising:
a cargo container comprising a base wall, a top wall and at least one side wall defining an interior space of the cargo container;
an enclosure removably positioned within the interior space of the cargo container, the enclosure comprising at least one wall forming an interior cargo space; and
a fire suppression device located at least partially within the interior space of the cargo container;
wherein the at least one wall of the enclosure is spaced a distance from the at least one side wall of the cargo container, wherein the distance forms a gap between the at least one wall of the enclosure and the at least one side wall of the cargo container; and
wherein the at least one wall of the enclosure includes one or more openings that provide a fluid communication path between the interior space of the cargo container, the gap, the enclosure, and the interior cargo space of the enclosure.

2. The cargo containment system of claim 1, further comprising one or more spacers located within the gap between the at least one wall of the enclosure and the at least one side wall of the cargo container.

3. The cargo containment system of claim 2, wherein the spacers are mounted to the at least one side wall of the cargo container.

4. The cargo containment of claim 2, wherein the spacers are mounted to the at least one wall of the enclosure.

5. The cargo containment system of claim 1, wherein the at least one wall of the enclosure constructed from a permeable material.

6. The cargo containment system of claim 1, wherein the at least one wall of the enclosure comprises a plurality of openings that provide access to the interior cargo space of the enclosure.

7. The cargo containment system of claim 1, wherein the fire suppression device is configured to discharging an extinguishing material within the interior space of the cargo container.

8. The cargo containment system of claim 7, wherein the extinguishing material is configured for traveling into the gap between the enclosure and the at least one side wall of the cargo container, and subsequently through the at least one opening of the at least one wall of the enclosure.

9. The cargo containment system of claim 1, wherein the fire suppression system is configured to discharge a smoke material through an outlet extending outside the cargo container.

10. The cargo containment system of claim 1, wherein the enclosure includes one or more wheels for selectively moving and removing the enclosure from the interior space of the cargo container.

11. The cargo containment system of claim 1, wherein the fire suppression device is mounted adjacent the top wall of the cargo container.

12. The cargo containment system of claim 1, wherein the enclosure is configured as a permeable liner.

13. A fire suppression equipped cargo container comprising:
a cargo structure comprising at least one container wall;
an enclosure cage configured for holding cargo, the enclosure cage comprising at least one enclosure wall having a plurality of openings defined therethrough; and
a fire suppression system mounted within the cargo structure;
wherein the enclosure cage is configured for being positioned entirely within the cargo structure such that a gap is formed between the at least one container wall and the at least one enclosure wall;
wherein the fire suppression system is configured to discharge a fire suppression material within the cargo structure upon detection of a potential fire hazard; and
wherein the gap enables the discharged fire suppression material to fully surround cargo that is located within the enclosure to assist in suppression a fire hazard within the cargo structure.

14. The fire suppression equipped cargo container of claim 13, further comprising one or more spacers provided between the at least one container wall and the at least one enclosure wall for maintaining the gap therebetween.

15. The fire suppression equipped cargo container of claim 13, wherein the gap is at least 0.5 inches wide.

16. The fire suppression equipped cargo container of claim 13, wherein the gap is continuous around the entirety of the enclosure cage.

17. The fire suppression equipped cargo container of claim 13, wherein the enclosure cage comprises a permeable liner.

18. A cargo containment system comprising:
an outer cargo structure defining an outer shell, the outer cargo structure having an interior space and an enclosure surface around the interior space;
an inner enclosure configured to be selectively positioned within the interior space of the outer cargo structure;
at least one spacer extending between the inner enclosure and the enclosure surface of the outer cargo structure, the at least one spacer defining a gap between the outer enclosure and enclosure surface; and
a fire suppression unit located at least partially within the outer cargo structure and above the inner enclosure;
wherein a continuous dispersion path is formed from the fire suppression unit to the gap to enable fluid communication between the fire suppression unit and the inner enclosure along one or more sides of the inner enclosure.

19. The cargo containment system of claim 18, wherein the inner enclosure comprises a plurality of openings through a surface of the inner enclosure.

20. The cargo container device of claim 18, wherein the inner enclosure an outer surface and an inner cargo chamber within the outer surface, and wherein the outer surface forms a porous, permeable or semi-permeable barrier for the inner cargo chamber.
